(19) United States
(12) Patent Application Publication
(10) Pub. No.: US 2005/0114225 A1
(43) Pub. Date: May 26, 2005

(54) Product auctions

(76) Inventors: Robert Longman, Chicago, IL (US); Sophia C. Li, Chicago, IL (US)

Correspondence Address: ATTN: ROBERT LONGMAN & SOPHIA C. LI;SMART AUCTIONS, INC., 1749 GOLF ROAD, UNIT #145, MOUNT PROSPECT, IL, 60056, US

(21) Appl. No.: 10/720,914

(22) Filed: Nov. 24, 2003

(51) Int. Cl. G06F 17/60

(52) U.S. Cl. 705/26

(57) ABSTRACT

The present invention provides a fresh method and system for conducting sealed offer online auctions for the purpose of price discovery related to new products and services. Instead of the traditional marketing scheme, the present invention harmonizes the theory of price discovery in economics with the theory of sample marketing. The purpose of a New Product Auction is to raise awareness of a particular product through online actions while discover the true market price for that product in order to establish a selling price later on. In a New Product Auction, the seller/marker of a new product will offer a set amount (greater than one) of that product in a no reserve online auction. The seller/maker will give description about the usages and benefits of the product, and buyers will place sealed bid on such new product based on their perception of value about that product. The auction has a scheduled deadline tracked by the auction system provider and selected by the seller/maker of the product; all bids are sorted based on time of entry and are sealed during the auction process. Winners of the auction will vary depending on diverse scenarios (as addressed in Detailed Description). Each buyer is entitled to only one such product if he/she wins. The winning price of such an auction will be a single price for all winners, calculated based on a selected statistical averaging method. The winners will be required to leave online comments about the product upon receipt of the product. The seller/maker then will list another round of New Product Auction for the same product, and the bidding process will repeat itself, except that the winners in the first round of auction will not be allowed to participate again regarding the same product. The second round of bidders will determine their bids based on their valuation of the new product and the feedbacks from the first round of winners. A seller/maker can select any number of rounds sufficient enough for it to determine the true market price before making a serious commitment to manufacture or market such a product.

### FIELD OF INVENTION

The invention relates to auctions and more particularly to online auctions for goods and services.

### BACKGROUD

Both computer and Internet use have increased substantially in the past few years. Since 1997 computer use has grown at a rate of 5.3 percent on an annualized basis. Internet use has grown at a rate of 20 percent a year since 1998. Increasingly, we are a nation online. Individuals continue to expand their use of computers and the Internet. Nearly half of the population now uses e-mail, and approximately one-third of Americans uses the Internet to search for product and service information.

There are 429 million Internet user world wide, accounts for 7% of the population, and the average amount of online shoppers out of all Internet users worldwide is 15%. Today, 60% of U.S. populations have access to the Internet, and the United States has the highest shopper to Internet user ratio of 35%. As the computer and Internet technologies advance, Internet access will be provided to a broader user base at substantially lower costs.

Global Internet media companies such as Yahoo! Inc. offers a comprehensive branded network of services to more than 166 million individuals worldwide. As the leading guide in terms of traffic, advertising, and household and business users reach, Internet supplies businesses like Yahoo! with remarkable opportunity to market any product and service to broad range of consumers at a rapid pace.

Similarly, online auctions speak for the other aspect of Internet success stories. In 1998, there was $1.4 billion worth of consumers' auctions; in 2003 that figure is expected to rise to $19 billion. It is said that the next wave of web auctions will come from regular retailers. As the online auction market grows, its distribution will shift away from the person-to-person format. In 1998 person-to-person sales made up 70% of online auctions and business-to-consumer just 30%, but Massachusetts-based Forrester Research expects that by 2003 business-to-consumer auctions will rise to 66% of the market.

Such tremendous growth potential in both online auctions and online marketing inspire us to discover a new way of thinking and to design an online marketing system that will utilize the theory of price discovery to serve online marketers with express knowledge about new product pricing and experiences according to the data collected using a new format of business-to-consumer auction.

### SUMMARY OF THE INVENTION

The present invention provides a fresh method and system for conducting sealed offer online auctions for the purpose of price discovery related to new products and services. Instead of the traditional marketing scheme, the present invention harmonizes the theory of price discovery in economics with the theory of sample marketing. The purpose of a New Product Auction is to raise awareness of a particular product through online actions while discover the true market price for that product in order to establish a selling price later on. In a New Product Auction, the seller/marker of a new product will offer a set amount (greater than one) of that product in a no reserve online auction. The seller/maker will give description about the usages and benefits of the product, and buyers will place sealed bid on such new product based on their perception of value about that product. The auction has a scheduled deadline tracked by the auction system provider and selected by the seller/maker of the product; all bids are sorted based on time of entry and are sealed during the auction process. Winners of the auction will vary depending on diverse scenarios (as addressed in Detailed Description). Each buyer is entitled to only one such product if he/she wins. The winning price of such an auction will be a single price for all winners, calculated based on a selected statistical averaging method. The winners will be required to leave online comments about the product upon receipt of the product. The seller/maker then will list another round of New Product Auction for the same product, and the bidding process will repeat itself, except that the winners in the first round of auction will not be allowed to participate again regarding the same product. The second round of bidders will determine their bids based on their valuation of the new product and the feedbacks from the first round of winners. A seller/maker can select any number of rounds sufficient enough for it to determine the true market price before making a serious commitment to manufacture or market such a product.

### BRIEF DESCRIPTION OF THE DRAWINGS

FIG. 1 is an overall diagram of the system.

FIG. 2 illustrates the elements on a web page for conducting a New Product Auction.

FIG. 3 is a high level flow diagram of the various operations that take place on a seller's end.

FIG. 4 is a spread sheet showing the auction process scenario when the total bids exceeds the available quantity.

FIG. 5 is a spread sheet showing the auction process scenario when the total bids equals to the available quantity.

FIG. 6 is a spread sheet showing the auction process scenario when the total bids are less than the available quantity but exceed the effective level.

FIG. 7 is a flow diagram showing the functionality of disqualifying multiple bids placed by a single bidder.

FIG. 8 is a spread sheet showing the auction process scenario when there is a single bidder places multiple bids.

### DESCRIPTION OF PREFERRED EMBODIMENTS

As used herein the following terms have the meaning given below:

1. “Product”-means goods and services, rights or properties that are still in development stage or have not yet been mass marketed to consumers.

2. “Seller” means maker or provider of particular goods or services.

3. “Auction Duration”-means the period between the auction start date and scheduled end date.

4. “User ID”-means the identification a buyer or seller use during the auction process.

5. “Sealed Offer” means all bid prices are undisclosed to any buyer and any seller during the auction process.

6. “Winning Bid” or “Winning Price”-means the price that wins the product at the end of an auction.

7. “Time of Entry” indicates the time when bidders place their bids. It is important to record time of entry in case there is a tie in bid prices. If that occurs, the bidder who places the same bid price earlier will claim priority right over the later.

8. “System Controller”—means a computer system or web server that performs various calculations and operations hereinafter described.

9. “System Operator”—means an individual, company, party, entrepreneur or other entity that operates or is responsible for the computer system or web server that performs various calculations and operations hereinafter described. This entity will act as the liaison between sellers and buyers for conducting an online Buyer's Offer auction.

10. “Participating Buyer”—means anyone within the system network who has actually placed bid on the product being auctioned.

11. “Effective Level” is a percentage rate in respect to the total available quantity offered by the seller. This rate is set by the seller of the auction. If the total bids in said auction are less than the level set by the seller, there is no winner, and all bids are invalid. If the total bids in said auction exceed the level set by the sell, system controller is instructed to proceed and determine winners and winning bid in said auction.

Effective level is set based on the number of bids rather than the number of bidders. Although some may argue that effective level based on the number of bidders is a better indication of participation rate in an auction, it is simply the truth that no single bidder will have the incentive or need to place more than one bid unless the number of participants in a no reserve auction exceeds the available quantity.

12. “Auction Rounds” means the number of repeated auction listings for the same product in a multi-round auction. Auction rounds are set by the seller of the auction for the purpose of evening out the varying number of bidders online throughout a set time period. In general, more rounds mean better accuracy in determining the true market demand for the product, thus obtain better estimate of true market price for the product as well.

13. “Time Interval” is the time leap between each scheduled auction round in a multi-round auction. This gives enough time for both parties to complete the transaction and for the winners in each round to leave comments about the product so that their experiences with the product will serve as references for future bidders.

### DETAILED DESCRIPTION OF THE INVENTION

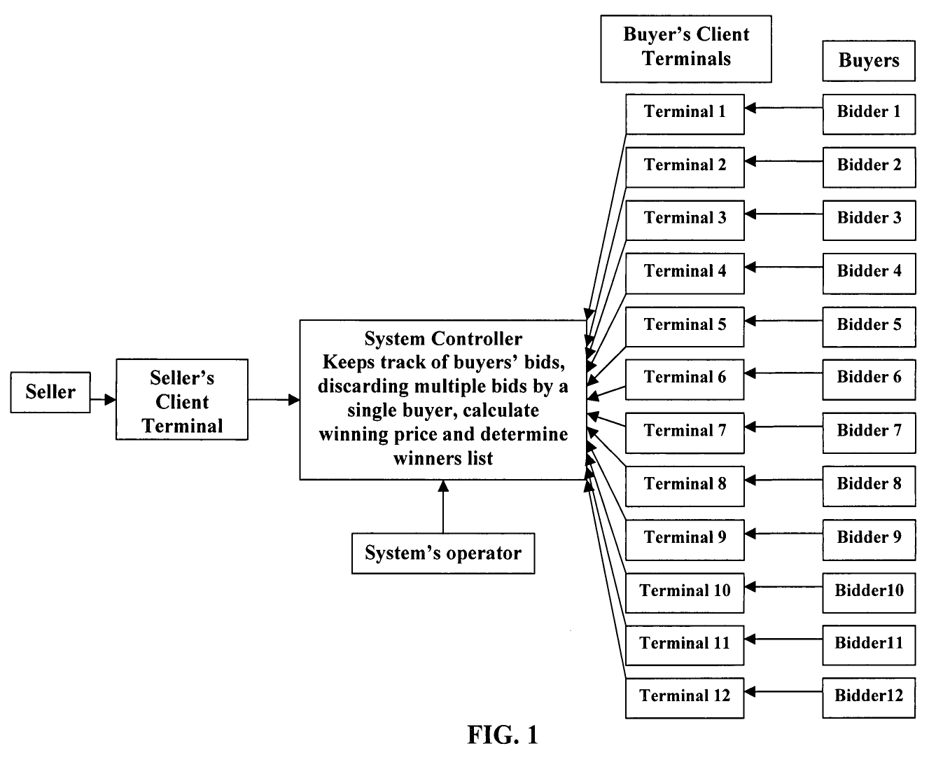

An overall diagram of the invention is shown in FIG. 1. For each New Product auction, the system connects the single seller with plurality of individual buyers by means of a system controller. There can only be one seller for each listing auction; however, the actual numbers of buyers for each auction can be greater or less than twelve as long as there is enough participating bidders to meet the effective level set by the seller to sustain a valid auction result. The system controller can handle almost unrestricted amount of auction listings; at any time, there are plurality of buyers, plurality of sellers, and plurality of auctions within the system network.

The seller communicates with the controller via the seller's client terminal, and the buyers 1 to 12 communicate with the controller via buyers' client terminals 1 to 12. Communication is via the Internet. Both the seller and the buyers' terminals are connected to an ISP (Internet Service Provider) which provides access to the Internet. Correspondingly, controller is also connected to the Internet via an ISP. The drawing lines in FIG. 1 thus represent logical information flow and not physical connections. The seller and the buyers 1 to 12 are described as being online.

The seller's client terminal can be a variety of forms of terminals that are obtainable such as computers, laptops, WebTVs, PDAs, information appliances, or any other devices that can be used by the seller to access the system controller over a network, so the seller can specify description and duration of the new product it is offering and communicate with participating buyers.

The system controller is one or more network servers running software to keep track the seller's description and auction duration; “intelligently” manage appearance of the auction listing on one or more virtual media such as web sites; and correctly track or process bids posted by buyers who participate in the auction.

The system operator utilizes a client terminal to access and configure the system's controller as is conventional with computer systems and network servers.

The buyers' client terminal 1 to 12 are any of the various forms of terminals that are employed to access web sites such as computers, laptops, thin-client, WebTVs, two-way TV, PDAs, information appliances, or any other devices that buyers may utilize to learn auction listings presented by the controller, to post bids and to communicate with the seller regarding the product offering using buyers' client terminals.

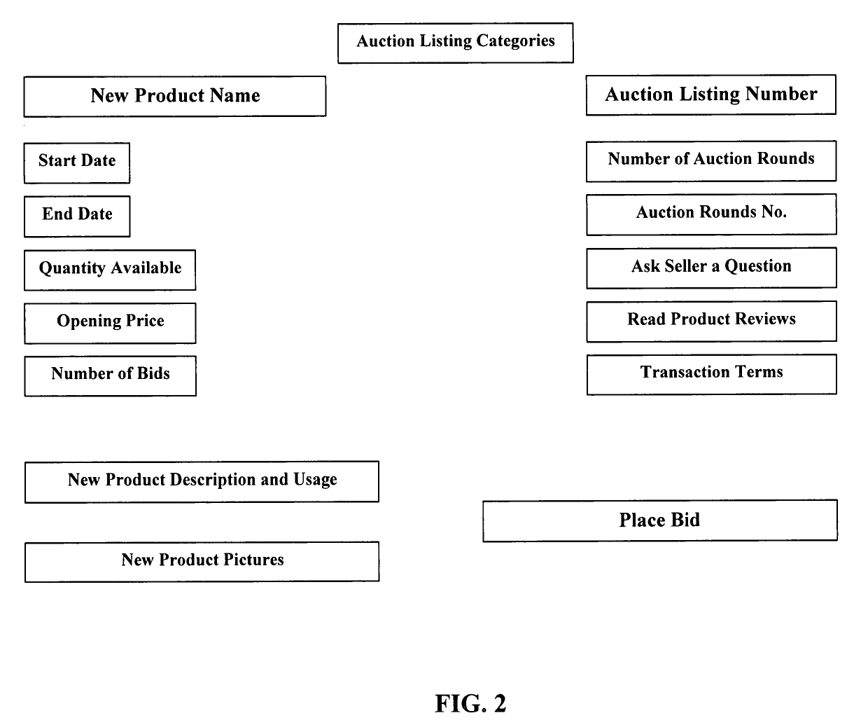

FIG. 2 is a diagram illustrating the elements on a web page which the controller presents to buyers 1 to 6. It is noted that FIG. 2 merely illustrates the fields that are relevant to a preferred embodiment of the invention. FIG. 2 is not meant to illustrate the actual layout of a web page. An actual web page would be laid out in a creative, artistic fashion so as to present a pleasing visual appearance. The artistic nature of the visual appearance of the web page is not relevant to the present invention.

a) “Auction Listing Categories” is a brief reference of the nature of the item being auctioned. It is relevant to the system's categorization function, but such field is not required for the purpose of system operation.

b) “New Product Name” may include a brief description of the item being auctioned. It is relevant to the system's search function used by sellers, but such field is not actually essential to the operation of the system.

c) “Auction Listing Number” is a series of computer generated numbers which is implemented by the system controller for identification purpose.

d) “Start date” and “End date” determines the auction duration.

e) “Quantity Available” indicates the maximum quantity availability in each round of auction.

f) “Opening Price” is the lowest acceptable price for a product if bidders wish to participate. Opening price is set by the seller; however, in a New Product Auction, seller is recommended to start the opening price as low as $0.01 in order to discover true market price for that product.

g) “Number of Bids” in general implies the attractiveness of an auction, and is practical for the seller, the buyers, and the system controller.

h) “Number of Auction Rounds” means the total number of auction rounds chosen by the seller at the beginning of the auction for said new product. A new product auction comprises multiple rounds of auctions, and a new product auction is only completed after all rounds of auctions have been fulfilled.

i) “Auction Round No.” indicates the specific round of auction in a multi-round auction process.

j) “Ask Seller a Question” is a function allows buyers to communicate with the seller regarding questions concerning the product in auction.

k) “Read Product Reviews” is a history of reviews about the said product posted by previous auction rounds winners after trying the said product.

l) “Transaction Terms” are information associated with shipping and payment stipulations. Although seller can set its own terms, it is highly recommended that seller offer free shipping to buyers so that transaction costs will not alter buyers' precise valuation about a product.

m) “New Product Description and Usage” is a detailed account about the quality and usage related to the new product.
n) “New Product Pictures” are images or drawings related to the new product in auction.

o) “Place Bid” is a function allows buyers to place sealed bids on the product.

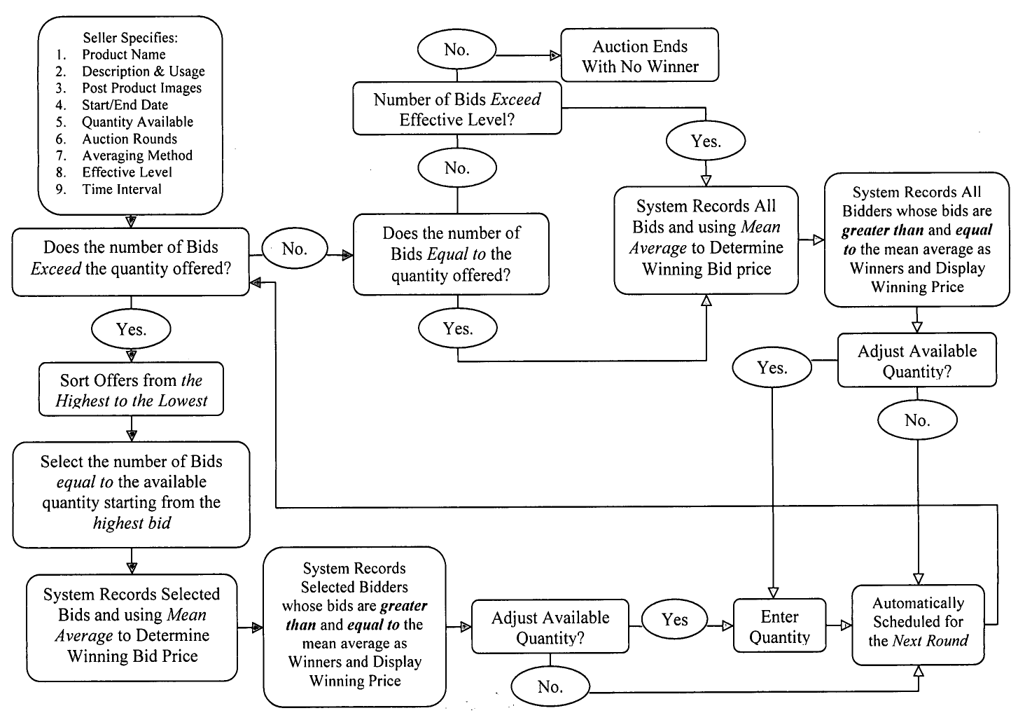

FIG. 3 is a high level flow diagram of the various operations that take place on a seller's end. The process begins when the seller/maker of a particular product posts a listing to sell certain quantity of such product. The seller will specify the name of the product, description and usage of the product, related product images, auction duration, available quantity, auction rounds, and averaging method, effective level, and time interval.

Once the auction starts, the system controller will keep track and maintain all bids placed on the auction. Upon closing of the auction, the system controller will determine whether the number of bids exceeds the available quantity. If number of bids exceeds the available quantity, the system controller will sort all bids based on price from the highest to the lowest. The system controller will then choose equal amount of bids to match the available quantity starting from the highest bids. Subsequently, the system controller will also record all chosen bids and determine the uniform winning bid through a selected averaging method. The winner of 1^{st} round of auction will be those buyers whose bids are greater than and equal to the winning bid price.

If the number of bids is equal to the available quantity, system controller will calculate based on all bids. If the number of bids is less than the available quantity, the system controller will determine whether total bids on the product exceed the effective level set by the seller. If the effective level is met, the system controller is programmed to record all bids and determine the winning bid using the chosen averaging method. Winners are those buyers whose bids are greater than and equal to the winning bid price. If the effective level is not met, all bids are deemed by the system controller as invalid. There is no winner for the auction, and no further round will proceed for that particular product.

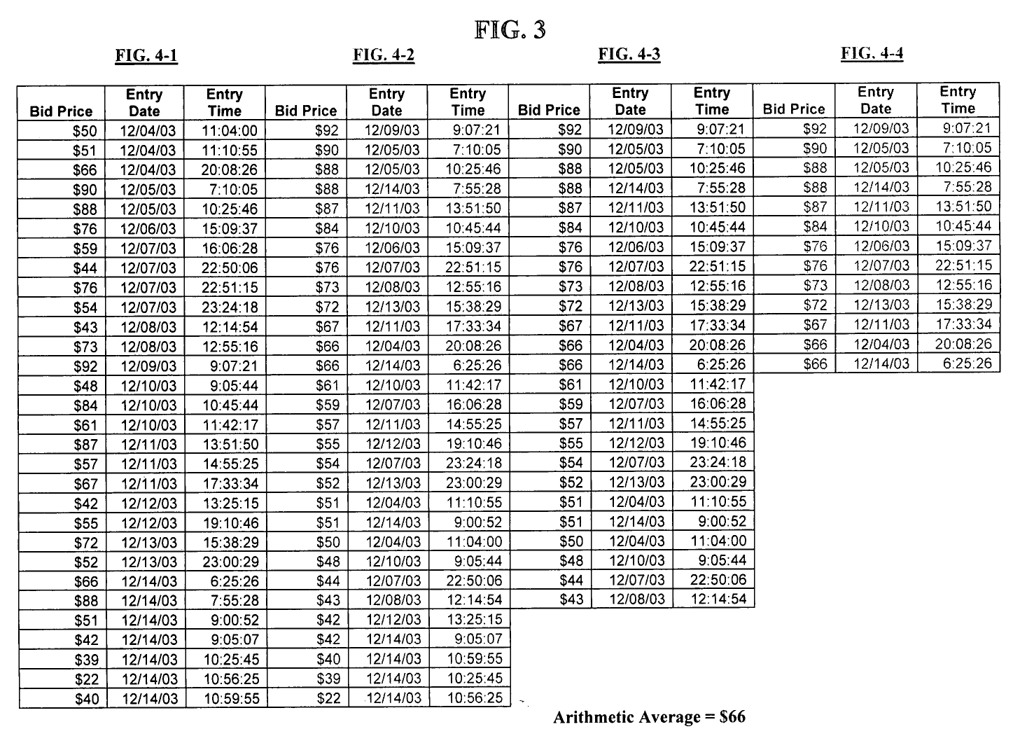

A detailed example is given in FIG. 4-FIG. 6:

An air filter manufacture has invented a new air filtration system. It wishes to sell them in a New Product Auction to determine the true market value of the product and find out whether it is feasible to commit in full production based on the feedbacks it receives from the auction winners. It specifies the details of auction:
Product Name: XYZ Air filtration system by XYZ manufacture
Description & Usage: Detailed
Post Product Images: Applied
Start Date: 12-04-2003 @ 11:00:00 am
End Date: 12-14-2003 @ 11:00:00 am
Quantity Available: 25
Auction Rounds: 3
Averaging Method: Mean Average
Effective Level: 20%
Time Interval: 10 days
Opening Price: $0.01
Shipping: Free
   Scenario 1 (Total Bids Exceed the Available Quantity)

Upon closing date of the auction on 12-14-2003 @ 11:00:00 am, the auction received 30 bids. These bids are sorted by the time of entry during the auction process and sealed from all buyers and the seller as shown in FIG. 4-1. Once the auction is ended, system controller is programmed to sort all bids according to price from the highest to the lowest. The results are shown in FIG. 4-2. Since the quantity available is 25, the system controller will select total 25 bids based on price from the highest to the lowest as shown in FIG. 4-3. System controller will calculate the average using arithmetic mean which comes out to be $66, and this price is established as the winning price for the 1^{st} round auction. The system controller will select all bids that are greater than and equal to $66, and buyers who placed those bids that are greater than and equal to $66 are declared the winners of 1^{st} round auction.

Scenario 2 (Total Bids are Equal to the Available Quantity)

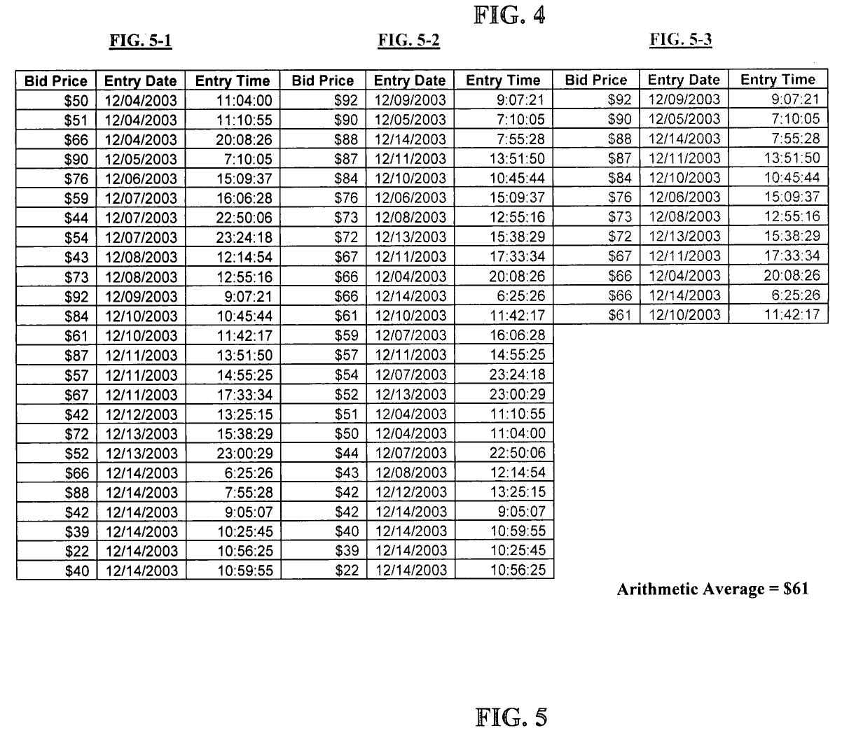

Upon closing date of the auction on 12-14-2003 @ 11:00:00 am, the auction received 25 bids. These bids are sorted by the time of entry during the auction process and sealed from all buyers and the seller as shown in FIG. 5-1. Once the auction is ended, system controller is programmed to sort all bids according to price from the highest to the lowest. The results are shown in FIG. 5-2. Since the quantity available is 25, the system controller will use all 25 bids for calculating the arithmetic average which comes out to be $61, and this price is established as the winning price for the 1^{st} round auction. The system controller will select all bids that are greater than and equal to $61, and buyers who placed those bids that are greater and equal to $61 are declared the winners of the 1^{st} round auction.

Scenario 3 (Total Bids are Less than the Available Quantity but Exceed the Effective Level)

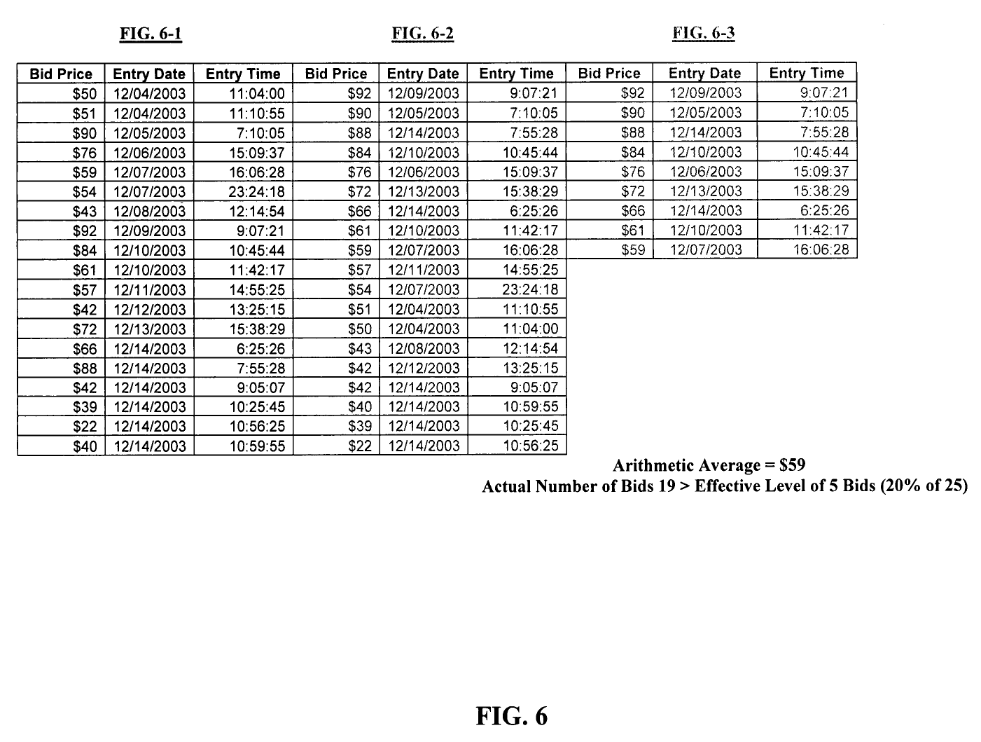

Upon closing date of the auction on 12-14-2003 @ 11:00:00 am, the auction received 19 bids, which is less than the available quantity. These bids are sorted by the time of entry during the auction process and sealed from all buyers and the seller as shown in FIG. 6-1. The system controller will automatically calculate the effective level for this auction at 5 bids. Since the total bids are greater than the effective level, the system controller will proceed to determine the winners and the winning bid price. Subsequently, system controller is programmed to sort all bids according to price from the highest to the lowest. The results are shown in FIG. 6-2. The system controller will use all 19 bids for calculating the arithmetic average which comes out to be $59, and this price is established as the winning price for the 1^{st} round auction. The system controller will select all bids that are greater than and equal to $59, and buyers who placed those bids that are greater and equal to $59 are declared the winners of the 1^{st} round auction.

Scenario 4 (Total Bids are Less Than the Effective Level)

Upon closing date of the auction on 12-14-2003 @ 1:00:00 am, the auction received 2 bids, which is less than the available quantity. The system controller will automatically calculate the effective level for this auction at 5 bids. Since the total bids are less than the effective level, the system controller will declare all bids invalid, and the auction ends with no winner. Thus, the auction will not proceed further to the next two scheduled rounds and ends completely.

For Scenario 1-3, upon the ending of 1^{st} round of auction, the seller is allowed to adjust available quantity as it deemed necessary to meet the demand based on 1^{st} round participation result. Once the adjustment is made, the 2 round auction will be scheduled for listing after the time interval expires. In the example above, time interval is 10 days, so the 2^{nd} round of auction for the same product will begin on 12-24-2003 @ 11:00:00 am and end on 01-03-2004 @ 11:00:00 am. The time interval gives the time for transaction to be completed and allows enough leap for 1^{st} round winners to leave comments about the product so that these comments can serve as reference for the next two rounds bidders.

The process of 2^{nd} round of auction will be the same as in the 1^{st} round. The auction will then proceed to the 3^{rd} round unless the total bids in the second round are less than the effective level. If so, the auction will end with only two rounds.

Suppose the winning prices for the three rounds are $66, $71, and $73, the seller may want to consider to price the product at $70 (using arithmetic average) if it decides to commit resources for full production. If the auction was unsuccessful due to lack of participants, the seller may want to abandon the idea of manufacturing or provide such product since there is not enough demand in the market to justify such investment.

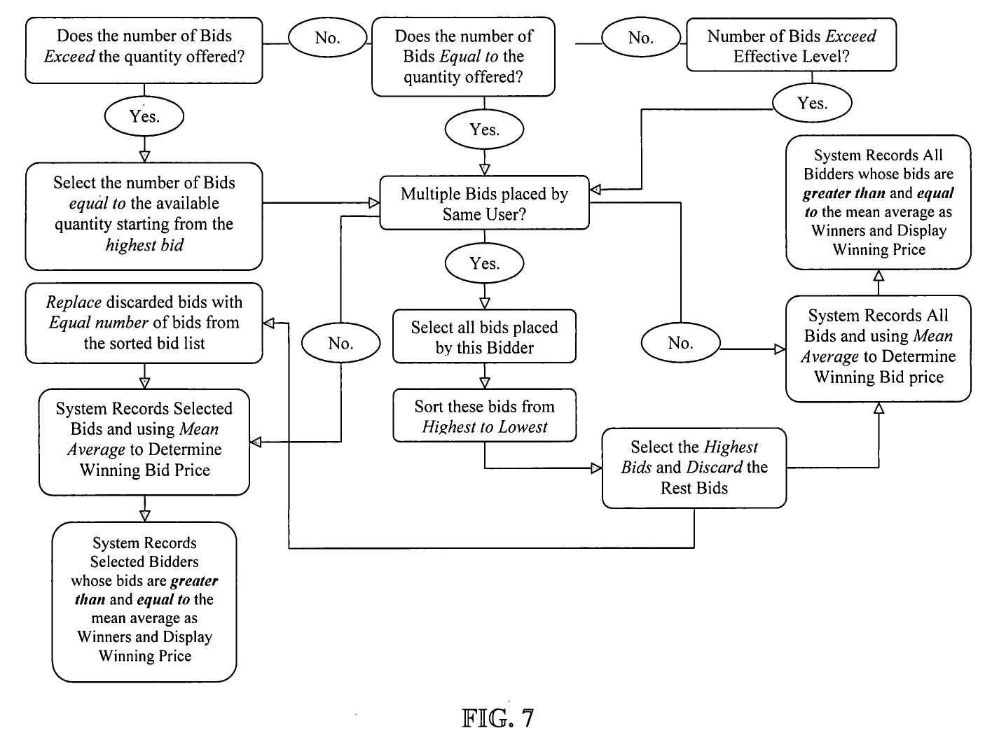

Since a New Product Auction is no reserve based auction, each bidder can place more than one bid on the product. However, each bidder is entitled to only one product so that more people are given the chances to try the product. It is likely that single bidder can have more than one bid accepted by the calculation procedures. Thus, it is up to the system controller to rule out multiple winning bids placed by the same buyer. FIG. 7 is a flow diagram of the functionality programmed into the system controller to discard multiple bids made by single bidder.

The process begins when the system controller determines whether the total bids have exceeded the available quantity. If yes, the system controller will sort all bids based on prices from the highest to the lowest and select equal number of bids starting from the highest to match the available quantity. Then the system controller will verify whether there are multiple bids placed by a single bidder. If yes, the system controller will select all bids placed by such a bidder and sort them according to prices from the highest to the lowest. The system controller will choose the highest bid and discard the rest of the bids made by such a bidder. The system controller will then replace discarded bids with Equal number of bids from the sorted bid list. After that, the process of determining the winning price and winners are the same as in FIG. 3. If total bids equal to the available quantity or if the total bids are less than the available quantity but exceed the effective level, the system controller will discard multiple bids placed by the same bidder using the exact method as shown in FIG. 7.

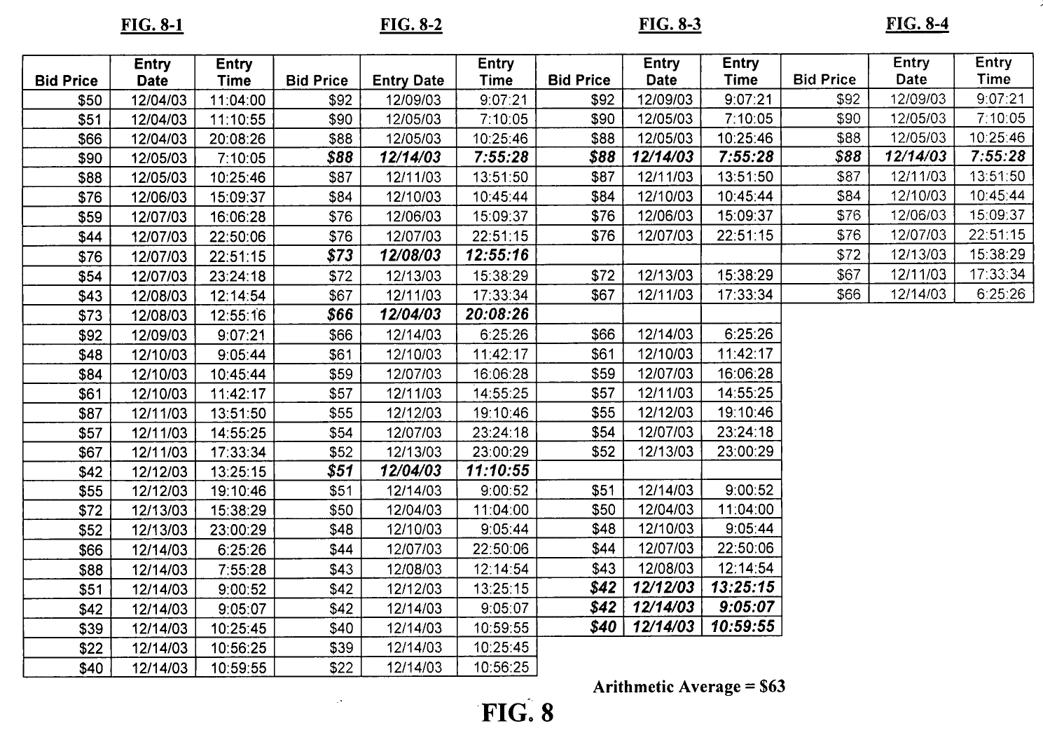

For instance, assume a single bidder has place total four bids over the period of auction listing in FIG. 8. Upon closing date of the auction on 12-14-2003 @ 11:00:00 am, the auction received 30 bids.

These bids are sorted by the time of entry during the auction process and sealed from all buyers and the seller as shown in FIG. 8-1. Once the auction is ended, system controller is programmed to sort all bids according to price from the highest to the lowest. The results are shown in FIG. 8-2. Since the quantity available is 25, the system controller will select total 25 bids based on price from the highest to the lowest. However, since a single bidder placed total 4 selected bids, system controller will discard the three lowest bids for that bidder and add three new bids from the list in FIG. 8-2. The result is shown in FIG. 8-3. System controller will calculate the average using arithmetic mean which comes out to be $63, and this price is established as the winning price. The system controller will select all bids that are greater than and equal to $63, and buyers who placed those bids that are greater than and equal to $63 are declared the winners.

As more rounds of auction are conducted, more and more comments about the product will be posted by previous winners. These feedbacks about the experiences using the product will serve as references for future bidders. These feedbacks also convey information about product value to new bidders as they will take them into account to derive at their own valuation concerning pricing. The differences between each auction winning bids are expected to diminish as the number of auction rounds increases.

Because the number of bidders available during a particular period varies, demand and supply for a particular product auctioned during such a period also fluctuates. New Product Auctions are for products that will be potentially mass produced in the future and are not unique items, so sellers should supply sufficient quantity of such products during said auction process so that shortage in supply will not alter the true market price of the products. The number of participating buyers affects the outcome of the winning bid for each round, thus it is recommended that seller should adjust product available quantity in each round depending on the participation number in the previous round in order to set an optimal quantity for price discovery purpose. For instance, if in the previous round, demand for such product far exceeded the maximum availability, then the seller is recommended to increase the quantity availability in the next round to match the demand in the last round. On the Contrary, if in the previous round, demand for such product is less than the available quantity, then the seller is recommended to reduce the quantity availability in the next round to match the demand in the last round. It is however not the case that seller must set supply amount to match previous demand amount since such method need not result in the most effective price discovery.

A New Product Auction is particular useful for new inventions which have not yet gained acceptance by consumer. Such auction method is also a cost-efficient way for large manufactures to determine the true market price of a new product without spending millions in traditional marketing campaigns. Said auction can also be applied to real estate development project.

By using a new product auction, maker of a particular item can determine whether it is feasible or impractical to manufacture a particular goods or provide a specific service based on true market price resulted from the multi-round auction process before making a serious commitment to mass produce and market such product.

New product auction utilizes the power of internet exposure to reach extraordinarily wide rages of consumers rather than focusing on sample groups in traditional marketing process for new goods and services. It is a cost-efficient, fast-paced, and result-oriented method for discovering the true market price and market potential of a new product. It serves as a powerful tool for collecting data in a fast-pace environment; nevertheless, the actual statistical methods employed by each seller could diverge in accordance with product nature and seller's insight.

It should be understood that while various embodiments of the invention have been described, those skilled in art could make various changes in form, detail, and design without departing from the principle, spirit, and scope of the invention described herein. Applicant's invention is limited only by the scope of the appended claims.

1. A method of conducting a sealed offer auction, the method comprising: a) multi-round auction process; b) a seller/marker of a new product will offer a set amount (greater than one) of that product in a no reserve online auction; c) seller/maker will give description about the usages and benefits of the product; d) the auction has a scheduled deadline tracked by the auction system provider and selected by the seller/maker of the product; d) all bids are sorted based on time of entry and are sealed during the auction process; f) buyers will place sealed bid on such new product based on their perception of value about that product; g) the number of winners of the auction will vary depending on diverse scenarios (as addressed in Detailed Description); h) each buyer is entitled to only one such product if he/she wins; i) the winning price of such an auction will be a single price for all winners; j) the winning price will be calculated based on a selected statistical averaging method; k) the winners will be required to leave online comments about the product upon receipt of the product; l) the seller/maker will then list a second round of New Product Auction for the same product, and the bidding process will repeat itself; m) the winners in the first round of auction will not be allowed to participate again regarding the same product; n) the second round of bidders will determine their bids based on their valuation of the new product and the feedbacks from the first round of winners; o) a seller/maker can select any number of rounds sufficient enough for it to determine the true market price before market the product nationwide.

2. A method as in claim 1 wherein said auction is an online auction.

3. A method as in claim 1 wherein said auction is for goods and services.

4. A method as in claim 1 wherein said auction is for rights or properties.

5. “Auction System Provider” in claim 1 is an online auction service provider or an online auction host.

6. An online system for conducting a seal offer auction, the system comprising:
A controller;
Seller's terminal which communicates with said controller whereby seller can enter and transmit, prior to the beginning of an auction, a listing for said more than one item, a listing comprising name of a product, descriptions and usages, related images, auction duration, quantity offered, auction rounds, averaging method, effective level, and time interval of the item the seller is offering;
Web pages which display said auction listing;
A plurality of individual buyer terminals which communicate with said controller whereby said plurality of individual buyers can place more than one sealed bids prior to the auction end;
Said controller displays all bids in a sealed manner, with said plurality of individual buyers' user IDs on the item according to time of entry to all users;
Said controller keeps track of number of rounds have been completed and to be completed in a multi-round auction process, and be able to automatically re-list auction listing after every round until all rounds have been completed.
Said controller is programmed to discard multiple bids placed by a single bidder;
Winners of said auction listing vary depending on different scenarios address later in detail description section;
A system time tracker which operates on said computer server to track bids posted by said plurality of individual buyers according to time of entry of said bids;
An email system which operates on said computer server to notify said seller and said plurality of individual buyers winner list to said auction listing; and the said email system allows communications between said seller and said plurality of individual buyers regarding said auction listing;
A database system which operates on said computer server to store information or data such as user IDs, passwords, email addresses, contact information, credit card numbers, banking account numbers, feedback histories, and all information related to auction listing, processing, and ending results;
A check out system which operates on said computer server to allow said seller enter and calculate total transaction amount and deliver said seller's contact information via email to said plurality of individual buyers; and the said check out system is programmed to display said winners' contact information to said seller upon auction closing.

7. The system recited in claim 5 operating in accordance with said specified and limited time period whereby bids for a particular listing are only accepted for said specified and limited time period.

8. The system recited in claim 5 wherein said seller terminal is terminal connected to the Internet.

9. The system recited in claim 5 wherein said plurality of individual buyers terminals are terminals connected to the Internet.

10. The system recited in claim 5 wherein said controller comprises a server.

11. The system recited in claim 5 wherein said seller terminal and said plurality of individual buyers terminals communicate with said controller via the Internet.
